(19) United States
(12) Patent Application Publication
(10) Pub. No.: US 2007/0157598 A1
(43) Pub. Date: Jul. 12, 2007

(54) Plastic components formed from 3D blow molding

(76) Inventors: Gagov Atanas, Marion, OH (US); Rathi Pankaj, Akron, OH (US)

Correspondence Address: ROETZEL AND ANDRESS, 222 SOUTH MAIN STREET, AKRON, OH, 44308, US

(21) Appl. No.: 11/507,694

(22) Filed: Aug. 22, 2006

Related U.S. Application Data
(60) Provisional application No. 60/710,220, filed on Aug. 22, 2005.

(51) Int. Cl. F01N 7/14; B29C 49/00

(52) U.S. Cl. 60/272; 425/522

(57) ABSTRACT

The present invention relates to ducts, pipes, and other complex convoluted parts (e.g., automotive parts) formed via 3D-blow molding, and to methods for making such ducts, pipes, and other complex convoluted parts out of a plastic material. In one embodiment, the present invention relates to exhaust ducts, exhaust pipes, and other complex convoluted exhaust parts formed via 3D-blow molding, and to methods for making such automotive and/or vehicular exhaust parts out of a plastic material.

### RELATED APPLICATION DATA

This application claims priority to previously filed U.S. Provisional Patent Application No. 60/710,220, filed on Aug. 22, 2005, entitled “Plastic Components Formed From 3D-Blow Molding”, which is hereby incorporated herein by reference in its entirety.

### FIELD OF THE INVENTION

The present invention relates to ducts, pipes, and other complex convoluted parts (e.g., automotive parts) formed via 3D-blow molding, and to methods for making such ducts, pipes, and other complex convoluted parts out of a plastic material. In one embodiment, the present invention relates to exhaust ducts, exhaust pipes, and other complex convoluted exhaust parts formed via 3D-blow molding, and to methods for making such automotive and/or vehicular exhaust parts out of a plastic material.

### BACKGROUND OF THE INVENTION

Plastics have become viable alternatives to traditional materials in many applications. Many automotive parts are manufactured in plastic because of advantages over traditional materials. The automotive industry desires lightweight and high strength components. The complexities of shape and better environmental properties have led to penetration of plastics in the interiors of the car. High performance plastics have also made their mark in “under the hood components”. Easy and quick manufacturing and simple assembly have made plastics a natural choice for various components. One possible use for plastic in the field of automotive parts is as an alternative material for the formation/production of various exhaust assembly parts. The use of plastic exhaust assembly components can, among other things, reduce the number of parts required to form a complete sub-assembly, provide for a simpler assembly operation at the assembly plant, reduce the weight associated with an exhaust sub-assembly or exhaust system, lower the production cost of exhaust sub-assemblies or exhaust systems, and improve the performance, durability and life expectancy of such exhaust sub-assemblies and/or systems.

Additionally, the use of plastic-based exhaust parts could reduce significantly and/or eliminate corrosion problems associated with traditional metal-based exhaust systems.

Accordingly, there is a need in the art for a process/method that permits the formation/production of exhaust ducts, exhaust pipes, and other complex convoluted exhaust parts from a suitable plastic material.

### SUMMARY OF THE INVENTION

The present invention relates to ducts, pipes, and other complex convoluted parts (e.g., automotive parts) formed via 3D-blow molding, and to methods for making such ducts, pipes, and other complex convoluted parts out of a plastic material. In one embodiment, the present invention relates to exhaust ducts, exhaust pipes, and other complex convoluted exhaust parts formed via 3D-blow molding, and to methods for making such automotive and/or vehicular exhaust parts out of a plastic material.

In one embodiment, the present invention relates to an exhaust system comprising: at least one pipe; and at least one muffler housing, wherein the at least one pipe and the at least one muffler housing are joined together and wherein the at least one pipe and the at least one muffler are formed from at least one plastic and/or polymeric compound.

In another embodiment, the present invention relates to an exhaust system comprising: a first pipe; at least one muffler housing, wherein the muffle housing contains therein at least one honeycomb structure, the at least one honeycomb structure aiding in noise reduction, and wherein the at least one muffler housing is operatively connected to the first pipe; and a second pipe, wherein the second pipe is operatively connected to the at least one muffler housing such that the combination of the first pipe, the at least one muffler housing and the second pipe form an exhaust system, wherein the first and second pipes, and the at least one muffler housing are formed from at least one plastic and/or polymeric compound.

In yet another embodiment, the present invention relates to a method for making an exhaust systems comprising the step of: using 3D-blow molding process to form an exhaust system from a suitable plastic and/or polymeric compound.

### BRIEF DESCRIPTION OF THE DRAWINGS

FIG. 1 is an outer view of an exhaust assembly according to one embodiment of the present invention;

FIG. 2 is a cut-away view of the exhaust assembly of FIG. 1; and

FIG. 3 contains exemplary dimensions for the exhaust assembly of FIG. 1.

### DESCRIPTION OF THE INVENTION

The present invention relates to ducts, pipes, and other complex convoluted parts (e.g., automotive parts) formed via 3D-blow molding, and to methods for making such ducts, pipes, and other complex convoluted parts out of a plastic material. In one embodiment, the present invention relates to exhaust ducts, exhaust pipes, and other complex convoluted exhaust parts formed via 3D-blow molding, and to methods for making such automotive and/or vehicular exhaust parts out of a plastic material.

As is discussed above, in one embodiment, the present invention utilizes three dimensional (3D) blow molding to form one or more components of an exhaust system. In this embodiment, 3D-blow molding is suitable for molding and/or forming one or more long, convoluted automotive ducts or pipes. Since in some instances it can be very difficult to form the extruded pipes in the required shape, 3D-blow molding is used in some embodiments of the present invention to overcome the shortcomings associated with traditional extrusion processes. Some of the advantages associated with 3D-blow molding are: (1) the ability to achieve a high level of accuracy in one process step; (2) the tendency of 3D-blow molding to minimize flash generation; and (3) the ability of 3D-blow molding to produce a 3D paruproduct having no vulnerable parting lines.

In one embodiment, the 3D-blow molding process of the present invention is a suction-based blow molding technique. In this embodiment, the suction-based blow molding technique is able to produce 3D parts made of high-temperature plastic and/or polymeric materials—i.e., plastic and/or polymeric materials having melt temperatures from 250 to 360° C. (480 to 680° F.). In suction blow molding, a form of extrusion blow molding, the parison is conveyed directly from the parison die head into a closed blow mold and is drawn through the mold by vacuum. Once the bottom end of the parison emerges from the blow mold, the parison is pinched off by shutters and then inflated, enabling complex three-dimensional shapes to be produced. A suction blow molding machine generally has an extruder with special screws designed for gentle plasticating and homogenizing of high-temperature materials. In one embodiment, the mold is pre-heated to prevent premature cooling of the parison as it is blow and/or sucked through the mold.

The use of 3D-blow molding in the process of the present invention permits one to design complex exhaust systems architectures and achieve same with little or no manufacturing difficulty. The process of the present invention enables, among other things, one to realize substantial time and economic advantages by eliminating various process steps associated with the production of metal exhaust components (e.g., bending; welding, etc.). The process of the present invention also improves the productivity and economics of prior art exhaust system manufacturing processes by permitting one to realize cost savings associated with, for example, a reduction in the amount of raw material waste. Furthermore, the process of the present invention permits a manufacturer to achieve better mechanical property control over the components in an exhaust system.

Three dimensional (3D) blow molding also has various advantages over conventional molding processes, which include, but are not limited to, higher molding quality due to absence of welding seams, no reduction of strength resulting from material accumulation or notches at welding seams, more uniform wall thickness distribution, low flash waste and consequently lower amount of regrind, lower operating costs due to the reduced amount of material to be melted and cooled and optimized wall thickness to compensate wall thickness variations in bends and in case of prior mold contact the radial wall thickness control is possible.

Material Selection:

With regard to material selection, one of the more important factors to be taken into consideration when selecting a plastic and/or polymeric material for use in an exhaust system component made in accordance with one embodiment of the present invention is the operating conditions that the exhaust system component will encounter. Some of the specific factors to consider include, but or not limited to, impact strength, rigidity, chemical compatibility, melt strength and processability. With regard to the exhaust system embodiments of the present invention, such embodiments typically utilize high performance plastic and/or polymeric compositions. This is because gases, that leave a catalytic converter are typically around 200° C. The durability of a plastic and/or polymeric composition at such an operating temperature is just one factor that needs to be taken into consideration when selecting a plastic and/or polymeric material to be used in connection with the present invention.

In one embodiment, a suitable plastic and/or polymeric material for use in connection with the present invention is a glass-filled polyphenylenesulfide (G-PPS). The low cost and favorable processing characteristics of G-PPS, make this compound an attractive choice for manufacturing 3D-blow molded articles in accordance with the present invention. Furthermore, the high stiffness, high heat resistance and outstanding stress crack resistance of G-PPS permit for exhaust systems components formed therefrom to perform in the aggressive chemical environments and over a wide range of working temperatures. As would be apparent to one of skill in the art, under the car parts have to possess the ability to sustain impacts from below, and G-PPS possess sufficient impact strength for such applications. Additionally, G-PPS does not suffer from a high water absorption rate. Table 1 below lists some properties for commercial grade G-PPS.

TABLE 1

| | | |
|---|---|---|
| Izod impact strength | 75-80 | J/m |
| Tensile modulus | 7-12 | GPa |
| Heat Deflection Temperature | 260° | C. |
| Upper Working Temperature | 230° | C. |

| | |
|---|---|
| Resistance to acids and alkalies | Good |
| Resistance to hydrocarbons and halogens | Good |

Other suitable high temperature plastic and/or polymeric materials for use in connection with the present invention include, but are not limited to, polyphthalamide, an aromatic polyester (e.g., Vectran® available from Solvay), one or more halogen containing polymers, one or more fluoropolymers (e.g., ethylene tetrafluorethylene and ethylene chlorotrifluoroethlyene available from Solvay), one or more polyphenylsulfone polymers (e.g., Radel R® available from Solvay), one or more polyethersulfone (e.g., Radel A® available from Solvay), one or more polyphthalamides (e.g., Amodel® available from Solvay), liquid crystal polymer compounds that contain one or more additives (e.g., Xydar® polymers available from Solvay), one or more aromatic polyketones (e.g., Kadel® polymers available from Solvay), one or more transparent amorphous thermoplastic polymer (e.g., sulfone polymers sold under the trade name Supradel® polymers available from Solvay), and combinations, blends and/or alloys of two or more thereof.

It should be noted that the present invention is not limited to just those materials detailed above. Rather, any plastic and/or polymeric material can be used in conjunction with the present invention so long as the material chosen can withstand operating temperatures of up to about 125° C., up to about 150° C., up to about 175° C., or up to about 200° C., or even up to about 250° C. Here, as well as elsewhere in the specification and claims, individual range limits may be combined.

Design Details:

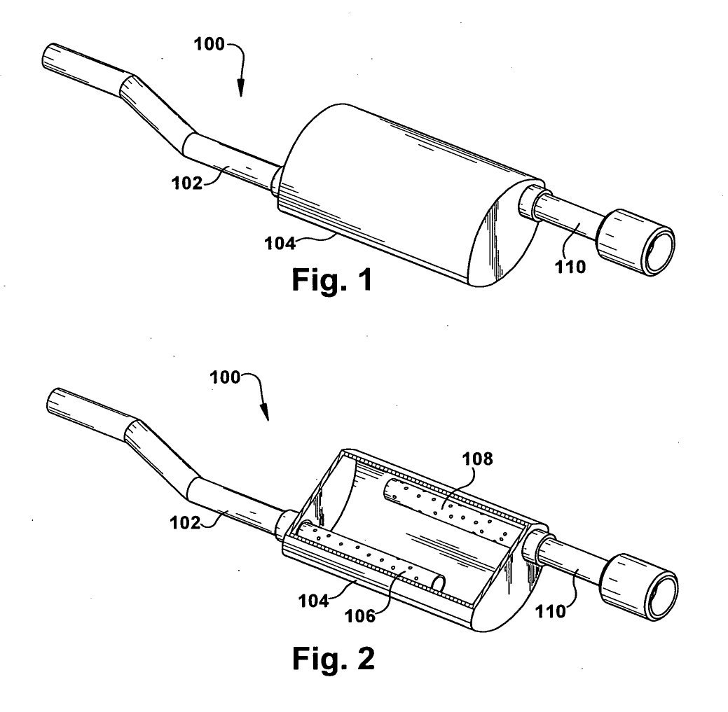

In one embodiment, an exhaust system in accordance with the present invention is illustrated in FIGS. 1 to 3. As is shown in FIGS. 1 to 3, an exhaust system 100 in accordance with the present invention comprises an A-pipe 102, a muffler housing 104, two honeycomb structures 106 and 108, and a B-pipe 110. As will be appreciated by those of skill in the art, exhaust system 100 is based on a design architecture associated with traditional exhaust systems. However, the present invention is not limited thereto. Rather, any exhaust system architecture can be used in conjunction with the present invention, so long as the design of the exhaust system lends itself to be formed by a 3D-blow molding process.

In one embodiment, A-pipe 102, muffler housing 104 and B-pipe 110 are individually blow molded and then fitted together to form exhaust system 100. During the formation of A-pipe 102 and B-pipe 110, respectively, honeycomb structures 106 and 108 are also formed simultaneously. In another embodiment, honeycomb structures 106 and 108 can be formed separately and then joined to their respective pipe components using any suitable attachment means (e.g., heat fusion, electro-fusion, mechanical fittings, and/or an adhesive means). In still another embodiment, honeycomb structures 106 and 108 can be formed from conventional materials such as metal or some metal alloy.

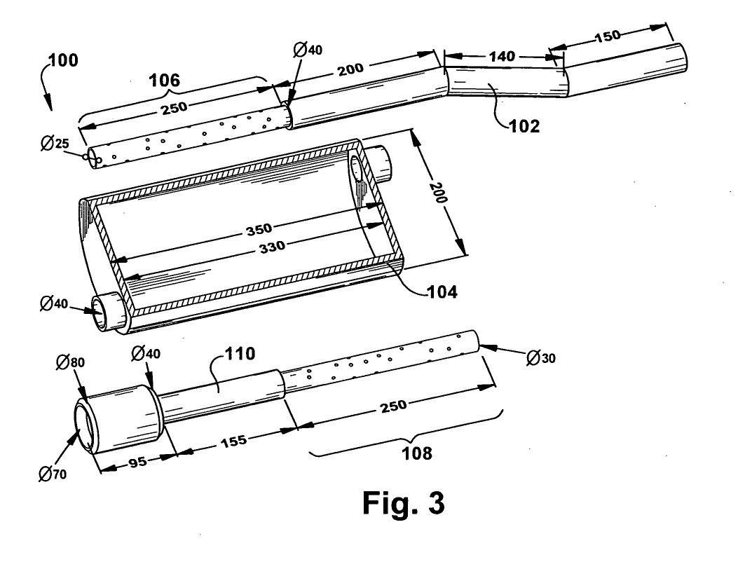

As is noted above, the present invention utilizes 3D-blow molding in the production of A-pipe 102 and B-pipe 110. Conventional blow molding processes or 3D-blow molding processes can be used to produce muffler housing 104. For more complicated muffler designs 3D-blow molding processes are typically utilized. Additionally, programmed parison extrusion can achieve the desired thickness in various sections of exhaust system 100. In the embodiment of FIGS. 1 and 3, honeycomb structures 106 and 108 are utilized to accomplish noise reduction.

In one embodiment, the thickness of the honeycomb structures 106 and 108, and A-pipe 102 is chosen to be 5 mm (0.1969″). The thickness of B-pipe 110 is selected to be 5 mm in the piping portion and 10 mm in the end portion that forms the exhaust tip. It should be noted that the above dimensions are exemplary in nature and that the present invention is not limited thereto. Instead, a wide range of desired thicknesses can be used in the formation of an exhaust system in accordance with the present invention.

In one embodiment, the muffler wall dimensions can be chosen appropriately to fulfill the mechanical requirements for the part (e.g., impact strength, bending, stiffness). One important parameter in this instance is the blow-up ratio—the ratio of the mold cavity diameter to the diameter of the parison or hollow form to be blown-up. A blow-up ratio of about 3:1 is recommended for the best wall thickness uniformity, although the present invention is not limited thereto. In another embodiment, any suitable blow-up ratio can be utilized so long as the blow-up ratio selected permits the formation of functional muffler components. The dimensions of the extrusion die are also chosen according to the design parameters of exhaust system 100.

As is discussed above, there are a number of common methods for joining the sub-components to yield a completed exhaust system 100. These methods include, but are not limited to, heat fusion, electro-fusion, mechanical fittings, and/or adhesive means. All of the above-mentioned joining methods are designed to provide leak-free plastic piping systems in the gas distribution industry. A-pipe 102 can be fitted onto a catalytic converter, not shown, using any suitable attached means (e.g., mechanical fasteners developed for plastics). In one embodiment, A-pipe 102 and B-pipe 110 can be joined to muffler housing 104 by a fusion method. In this embodiment, honeycomb structures 106 and 108 are mounted on A-pipe 102 and B-pipe 110, respectively, using a suitable adhesive. The assembled components are then inserted in to muffler housing 104 and fusion bonded to the end walls. Pipes 102 and 110 are supported under the car using hangers. Muffler housing 104 is supported via its connection to pipes 102 and 110.

Alternatively, elimination of honeycomb structures can be obtained through an innovative design of the muffler housing, which can lead to a single component system. The geometry and gap variation inside the housing can lead to sound reduction without the honeycomb structures. A simple obstructive geometry that causes reduction in exhaust gases velocity and destructive interference will reduce noise. In depth analysis of wave propagation can lead to custom exhaust systems based on various blow molded designs, which can have various sound levels. Accordingly, the present invention is intended to cover any muffler design irrespective or whether or not honeycomb structures are utilized therein.

Although the invention has been described in detail with particular reference to certain embodiments detailed herein, other embodiments can achieve the same results. Variations and modifications of the present invention will be obvious to those skilled in the art and the present invention is intended to cover in the appended claims all such modifications and equivalents.

What is claimed is:

1. An exhaust system comprising:
at least one pipe; and
at least one muffler housing,
wherein the at least one pipe and the at least one muffler housing are joined together and wherein the at least one pipe and the at least one muffler are formed from at least one plastic and/or polymeric compound.

2. The exhaust system of claim 1, wherein the at least one pipe and the at least one muffle housing are formed via a 3D-blow molding process.

3. The exhaust system of claim 2, wherein the 3D-blow molding process is a suction-based blow molding technique.

4. The exhaust system of claim 1, wherein the at least one plastic and/or polymeric compound can withstand an operating temperature of at least about 125° C.

5. The exhaust system of claim 1, wherein the at least one plastic and/or polymeric compound can withstand an operating temperature of at least about 150° C.

6. The exhaust system of claim 1, wherein the at least one plastic and/or polymeric compound can withstand an operating temperature of at least about 200° C.

7. The exhaust system of claim 1, wherein the at least one plastic and/or polymeric compound can withstand an operating temperature of at least about 250° C.

8. The exhaust system of claim 1, wherein the plastic and/or polymeric material is selected from one or more polyphthalamides, one or more aromatic polyesters, one or more halogen containing polymers, one or more fluoropolymers, one or more polyphenylsulfone polymers, one or more polyethersulfones, one or more polyphthalamides, one or more liquid crystal polymer compounds that contain one or more additives, one or more aromatic polyketones, one or more transparent amorphous thermoplastic polymers, and combinations, blends and/or alloys of two or more thereof.

9. The exhaust system of claim 1, wherein the plastic and/or polymeric material is one or more glass filled polyphenylenesulfides.

10. The exhaust system of claim 1, further comprising at least one honeycomb structure disposed within the at least one muffler housing, wherein the at least one honeycomb structure aids in noise reduction.

11. An exhaust system comprising:
a first pipe;
at least one muffler housing, wherein the muffle housing contains therein at least one honeycomb structure, the at least one honeycomb structure aiding in noise reduction, and wherein the at least one muffler housing is operatively connected to the first pipe; and
a second pipe, wherein the second pipe is operatively connected to the at least one muffler housing such that the combination of the first pipe, the at least one muffler housing and the second pipe form an exhaust system,
wherein the first and second pipes, and the at least one muffler housing are formed from at least one plastic and/or polymeric compound.

12. The exhaust system of claim 11, wherein the first pipe, the second pipe, and the at least one muffle housing are formed via a 3D-blow molding process.

13. The exhaust system of claim 12, wherein the 3D-blow molding process is a suction-based blow molding technique.

14. The exhaust system of claim 11, wherein the at least one plastic and/or polymeric compound can withstand an operating temperature of at least about 125° C.

15. The exhaust system of claim 11, wherein the at least one plastic and/or polymeric compound can withstand an operating temperature of at least about 150° C.

16. The exhaust system of claim 11, wherein the at least one plastic and/or polymeric compound can withstand an operating temperature of at least about 200° C.

17. The exhaust system of claim 11, wherein the at least one plastic and/or polymeric compound can withstand an operating temperature of at least about 250° C.

18. The exhaust system of claim 11, wherein the plastic and/or polymeric material is selected from one or more polyphthalamides, one or more aromatic polyesters, one or more halogen containing polymers, one or more fluoropolymers, one or more polyphenylsulfone polymers, one or more polyethersulfones, one or more polyphthalamides, one or more liquid crystal polymer compounds that contain one or more additives, one or more aromatic polyketones, one or more transparent amorphous thermoplastic polymers, and combinations, blends and/or alloys of two or more thereof.

19. The exhaust system of claim 11, wherein the plastic and/or polymeric material is one or more glass filled polyphenylenesulfides.

20. A method for making an exhaust system comprising the step of:
using 3D-blow molding process to form an exhaust system from a suitable plastic and/or polymeric compound.
